(19) United States
(12) Patent Application Publication
(10) Pub. No.: US 2025/0212732 A1
(43) Pub. Date: Jul. 3, 2025

(54) TRUCK BED LIFT ARM ASSEMBLY WITH TROUGH ALIGNABLE RECESS

(71) Applicant: Harper Industries, Inc., Harper, KS (US)

(72) Inventors: Joseph M. Biggerstaff, Garden Plain, KS (US); Caden Thul, Garden Plain, KS (US)

(73) Assignee: Harper Industries, Inc., Harper, KS (US)

(21) Appl. No.: 19/002,141

(22) Filed: Dec. 26, 2024

Related U.S. Application Data
(60) Provisional application No. 63/616,977, filed on Jan. 2, 2024.

(51) Int. Cl. A01D 90/08; B60P 1/48; B62D 33/02

(52) U.S. Cl. CPC A01D 90/08; B60P 1/48; B62D 33/02

(57) ABSTRACT

A flatbed truck bed for coupling a trailer to includes a base unit and a lifting assembly. The base unit has a loading surface and a trough centrally disposed between opposite sides of the base unit. The trough extends downwardly through the loading surface and rearwardly through a rear end of the base unit. The base unit includes a pivotable access hatch with a recessed portion that forms a section of the trough. The lifting assembly has a crossmember and a pair of arms attached to opposite ends of the crossmember. The crossmember is pivotable about an axis extending transverse to the longitudinal axis of the truck bed to extend the arms away from the truck bed. A recess extends into the crossmember and is alignable with the trough of the bed.

### CROSS REFERENCE TO RELATED APPLICATIONS

This application claims the benefit of U.S. Provisional Patent Application Ser. No. 63/616,977, entitled LIFT BED WITH TROUGH FOR FIFTH WHEEL HITCH, filed Jan. 2, 2024, the disclosure of which is incorporated herein in its entirety by reference.

### FIELD OF THE INVENTION

This invention relates to truck beds with lifting equipment for moving bales, reels, or other similar loads.

### BACKGROUND

Loaders of bales, spools, reels, and other similar loads are well known in the art. For example, U.S. Pat. No. 10,212,887 to Ramer et al. and U.S. Pat. No. 11,136,213 to Russell et al. describe stowable bale lifting devices adapted for use with flatbed trucks. The devices include a pair of arms that is pivotable longitudinally with respect to the length of the truck to lift a bale onto the truck bed or lower the bale from the truck bed to the ground. When they are not being used to move a bale, the arms are stowed on the truck bed in an orientation that leaves the truck bed largely unobstructed. The truck can thus be used in other applications such as hauling materials other than bales-without removing the bale lifting device from the truck bed. The devices described in the '887 and '213 patents may include a cavity or recess in the truck bed in which a hitch ball or the like may be positioned to facilitate connecting a trailer to the truck.

Because the hitch or coupler portion of the trailer must be precisely oriented above the hitch ball before coupling, it can be difficult to properly position the truck relative to the trailer. Multiple attempts to properly position the truck may be required, resulting in lost time and user frustration. In addition, the front of the trailer must be raised high enough to lift the lower end of the trailer coupler to advance clear of the top of the truck bed until the trailer coupler is advanced into position over the hitch ball. The user must then lower the trailer to place the trailer coupler sufficiently close to the hitch ball for coupling.

As shown in U.S. Pat. No. 11,136,213 to Russell et al., it is known to provide a trough in the bed of a flat bed truck from the recess for the hitch ball to the rear of the bed to reduce the height the trailer must be raised and then lowered for coupling the trailer coupler of a trailer to the hitch ball of the flat-bed truck.

### SUMMARY

Embodiments of the invention are defined by the claims below, not this summary. A high-level overview of various aspects of the invention is provided here to introduce a selection of concepts that are further described in the Detailed Description section below. This summary is not intended to be used in isolation to determine the scope of the claimed subject matter. In brief, this disclosure describes, among other things, a truck bed with a lifting assembly to transfer loads and a trough for coupling and decoupling a trailer to and from the truck bed.

The truck bed includes a base unit disposed on a truck frame. A trough is centrally disposed between opposite sides of the base unit and extends downwardly from a loading surface of the base unit. The trough extends rearwardly through a rear end of the base unit and has two sections: a mounting section and an inlet section. An access door with a recessed portion is pivotably coupled to the base unit along a trailing edge of the mounting section and may form the inlet section of the trough. A crossmember is mounted along the rear end of the truck bed and is pivotable about an axis that is transverse to the length of the truck. An arm is mounted on each end of the crossmember and is pivotable from a position lying against the loading surface of the base unit to a position extending from the rear end of the base unit. An offset is centrally disposed between the opposite sides of the crossmember and may align with the trough.

### DESCRIPTION OF THE DRAWINGS

Illustrative embodiments of the invention are described in detail below with reference to the attached drawing figures, and wherein:

FIG. 1 is a perspective view of a truck bed in accordance with an embodiment of the invention viewed from above and to the right.

FIG. 2 is a top plan view of the truck bed of FIG. 1;

FIG. 3 is a bottom plan view of the truck bed of FIG. 1;

FIG. 4 is a perspective view of the truck bed of FIG. 1 viewed from above and to the left;

FIG. 5 is a perspective view of the truck bed of FIG. 1 viewed from above and to the right;

FIG. 6 is a fragmentary, bottom plan view of the truck bed of FIG. 1;

FIG. 7 is a rear elevation view of the truck bed of FIG. 1;

FIG. 8 is a top plan view of the truck bed of FIG. 1 depicted with cover panels removed for clarity;

FIG. 9 is a perspective view of the truck bed of FIG. 1, viewed from above and to the right and depicted with a lift assembly in an extended position;

FIG. 10 is a perspective view of the truck bed of FIG. 1, viewed from above and to the right and depicted with an access hatch in an open position.

### DETAILED DESCRIPTION

The subject matter of select embodiments of the invention is described with specificity herein to meet statutory requirements. But the description itself is not intended to necessarily limit the scope of the claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

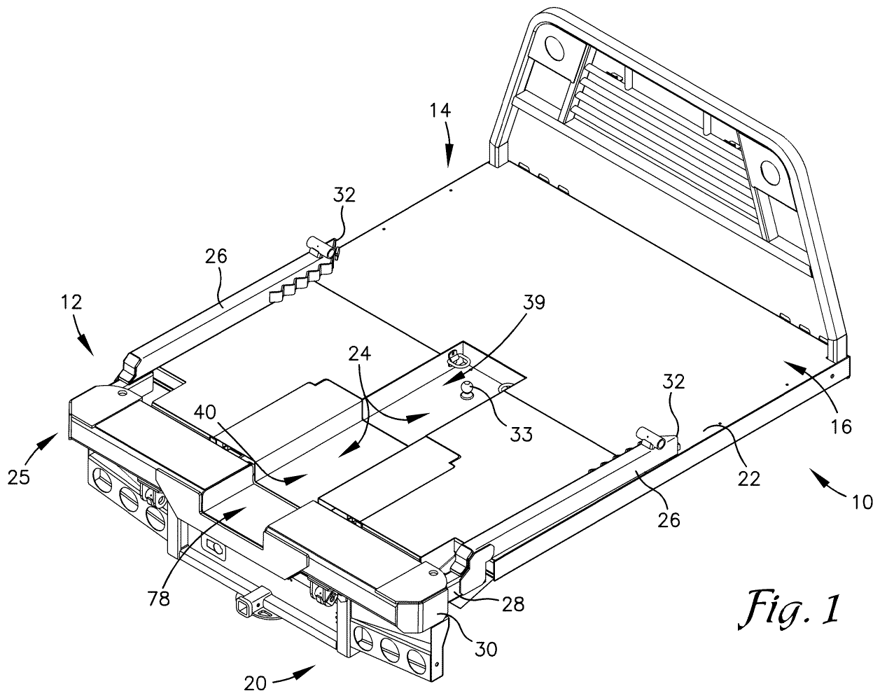

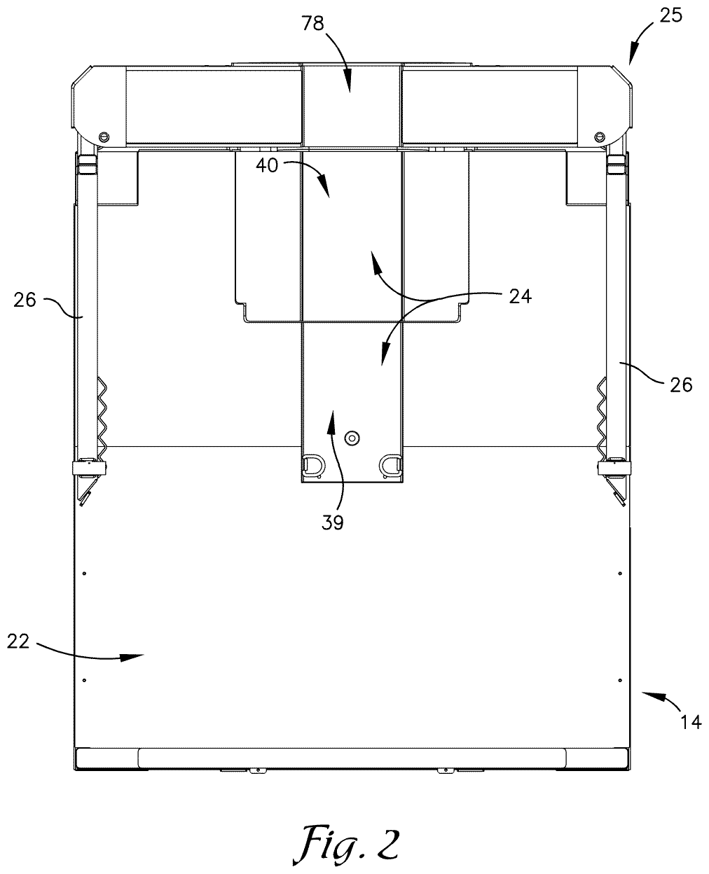

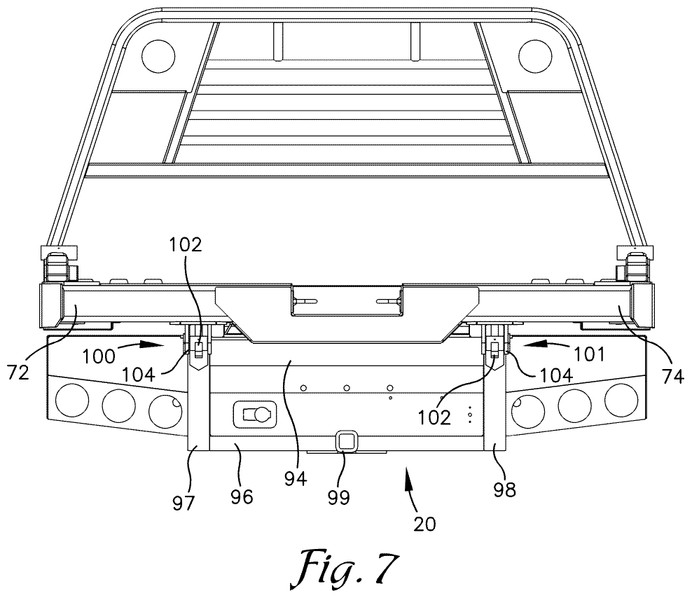

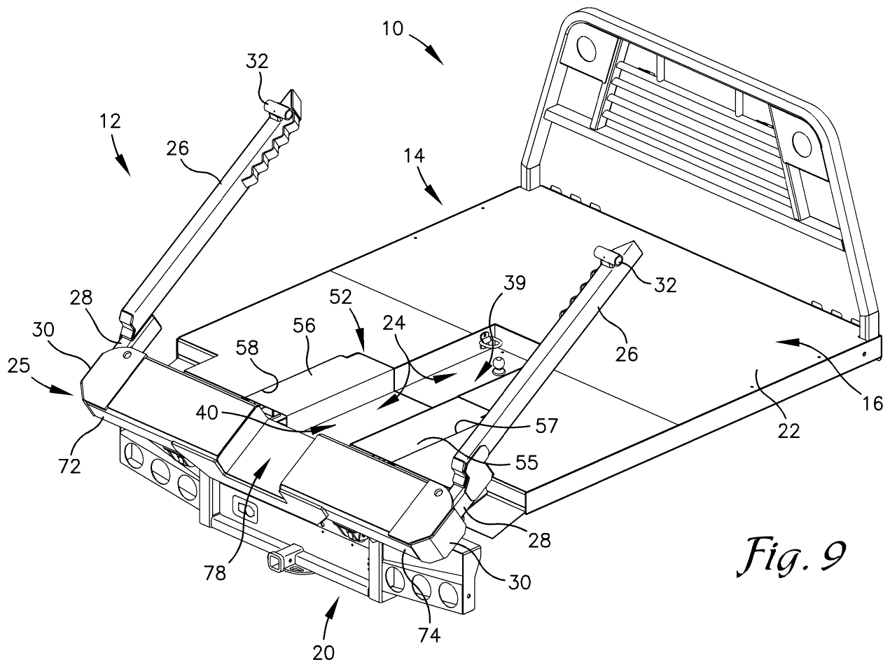

With reference to FIGS. 1-10, a truck bed 10 with a lift arm assembly 12 mounted thereon is described in accordance with an embodiment of the invention. The truck bed 10 with the lift arm assembly 12 is of the type adapted for lifting cylindrical bales of hay or reels of cable or conduit onto and off of the truck bed 10 and to facilitate unspooling of the material on the reel. The truck bed 10 comprises a base unit 14 and the lift arm assembly 12. The base unit 14 is adapted and configured to be secured to a truck frame (not shown) and comprises a truck bed floor or truck bed panel 16 mounted on a chassis 18 including a bumper or bumper structure 20. The truck bed floor 16 includes a generally flat upper surface or loading surface 22. A trough 24 is formed in the truck bed floor 16 and extends downward from the loading surface 22. The lifting assembly 12 is pivotably mounted to the base unit 14 and comprises a horizontal crossmember or strut 25 which is pivotably mounted to the chassis 18 above the bumper structure 20 and a pair of lift arms 26 which are pivotably connected at inner ends 28 thereof to opposite ends 30 of the crossmember 25. The lifting assembly 12 and the crossmember 25 thereof are pivotable between a retracted position and an extended position. The lift arms 26 are preferably pivotably connected to the crossmember 25 to allow inward and outward pivoting of the distal ends 32 of the lift arms 26 relative to each other.

Trough 24 is centrally oriented along a horizontal axis between opposite lateral ends of base unit 14 and extends downwardly from the loading surface 22. The trough 24 is preferably sized such that a hitch ball 33 mounted to the chassis 18 and projecting upward within the trough 24 does not extend above the loading surface 22 of the truck bed floor 16. In some embodiments, trough 24 extends downward from the loading surface 22 approximately six inches. The terms “about” or “approximately” as used herein denote deviations from the exact value by +/−10%, preferably by +/−5%, and/or deviations in the form of changes that are insignificant to the function.

Trough 24 is centered between the sides of the truck bed floor 16 and the loading surface 22 thereof. A forward end 34 of trough 24 is disposed between the forward end of the truck bed floor 16 and a center point thereof. Trough 24 extends from its forward end 34 rearwardly through a rear end of the truck bed floor 16 of base unit 14. The trough 24 may be formed or defined by first and second sheet metal panels or side walls 36 and 37, which may be referred to as first and second trough side walls 36 and 37, and a trough floor 38. The first and second trough side walls 36 and 37 and the trough floor 38 are structurally supported by the chassis 18, which is disposed on the underside of base unit 14.

Trough 24 is sized sufficient to accommodate traversal of a trailer coupler (not shown) thereacross or in closely spaced relation above the trough 24 when a trailer (not shown) is coupled to or decoupled from the hitch ball 33 or other hitch member connected to the base unit 14. The trough 24 is typically a substantially rectangular prism, and it should be understood that the trough 24 may also comprise other geometries without departing from the scope of embodiments of the invention described herein. For example, the trough 24 may be a substantially trapezoidal or substantially triangular prism.

When a truck with the truck bed 10 and lift arm assembly 12 mounted thereon is moved to couple to or decouple from a trailer, the trough 24 reduces the height that the front of the trailer and trailer coupler must be raised to clear the truck bed floor 16 as the trailer coupler advances over the truck bed 10 until it extends over the hitch ball 33. It is also to be understood that the driver may use the trough 24 as a visual reference to guide the trailer coupler toward the hitch ball 33, thereby minimizing the amount of horizontal manipulation of the truck and/or trailer needed for coupling. The guiding effect of the trough 24 may thereby eliminate the need for a “spotter” or other means of locating the trailer coupler relative to the hitch ball 33.

Trough 24 comprises a hitching or mounting section 39 that defines a first segment of trough 24 and an inlet or channel section 40 that defines a second portion of trough 24. Mounting section 39 is disposed between inlet section 40 and the forward end 34 of the trough 24. Mounting section 39 is aligned with inlet section 40, such that the centerline of mounting section 39 and the centerline of inlet section 40 are colinear or axially aligned.

Mounting section 39 projects downwardly from loading surface 22, with a mounting section floor 41 establishing the depth of mounting section 39 relative to loading surface 22, which in one embodiment may be approximately six inches. First and second mounting section side walls 42 and 43 extend from horizontally opposite side edges of the mounting section floor 41, connecting the mounting section floor 41 with loading surface 22. In some embodiments, the first and second mounting section side walls 42 and 43 may be integrally formed with the mounting section floor 41. Typically, the first and second mounting section side walls 42 and 43 extend approximately orthogonally from the mounting section floor 41, but the first and second mounting section side walls 42 and 43 may also extend acutely or obtusely from the mounting section floor 41. Forward wall 44 extends from a forward edge of the trough floor 38, further connecting the trough floor 38 with loading surface 22. Forward wall 44 thereby establishes the forward end 34 of trough 24. In some embodiments, forward wall 44 may be integrally formed with mounting section 39. Typically, forward wall 44 extends approximately orthogonally from trough floor 38. However, forward wall 44 may also extend acutely or obtusely from trough floor 38.

Trough floor 38 has a hole or bore 45 extending therethrough and through which the hitch ball 33 may be connected to a hitch ball mount 46 connected to the chassis 18 of the truck bed 10 below the trough floor 38 defining the bottom of the trough 24. Hole 45 is centered along the centerline of hitching section 39, and typically is disposed nearer to the forward end of hitching section 39 than the rear end. Hole 45 provides access to the hitch ball mount 46. Hole 45 may be approximately one to two inches in diameter through which a threaded stem of the hitch ball 33 may extend. It is to be understood, however, that the hole 45 may also comprise other dimensions or geometries without departing from the scope of embodiments of the invention described herein. The trough floor 38 extends below the loading surface 22 of the truck bed floor 16 a distance less than the height of the hitch ball 33 secured within the trough 24. In an embodiment, the trough floor 38 extends approximately six inches below the truck bed floor loading surface 22. Safety rings or loops 47a and 47b are attached substantially adjacent to forward edges of the first and second trough side walls 36 and 37, respectively. When a trailer is coupled to a truck equipped with the truck bed 10 and lift arm assembly 12 described herein, hooked safety chains extending from the trailer are preferably attached to the safety rings 47a and 47b.

Inlet section 40 is disposed between hitching section 39 and the rear end of base unit 14. Inlet section 40 projects downwardly from loading surface 22 toward the ground. An inlet section floor 48 establishes the depth of inlet section 40, which in some preferred embodiments is approximately six inches. Side walls 49 and 50, which may be referred to as first and second side walls 49 and 50 or first and second inlet section side walls 49 and 50, extend from horizontally opposite side edges of the inlet section floor 48, connecting the inlet section floor 48 with the truck bed floor 16. In some embodiments, the first and second inlet section side walls 49 and 50 may be integrally formed with inlet section floor 48. Typically, the first and second inlet section side walls 49 and 50 extend approximately orthogonally from the inlet section floor 48; however, it is understood that the first and second inlet section side walls 49 and 50 may also extend acutely or obtusely from the inlet section floor 48. It is foreseen that the first and second inlet section side walls 49 and 50 may cooperate with the first and second mounting section side walls 43 and 44 to form the first and second trough side walls 36 and 37.

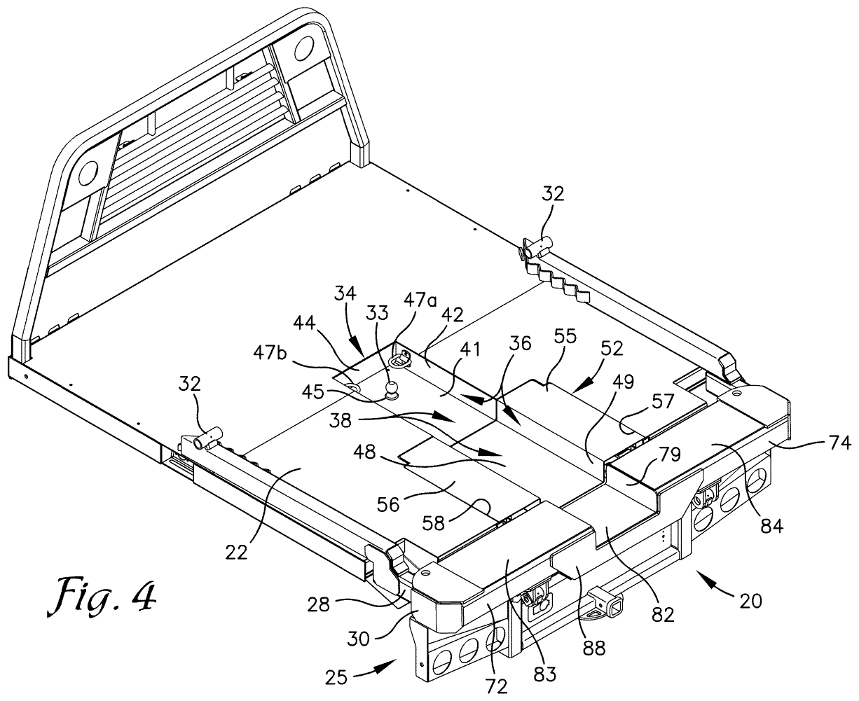

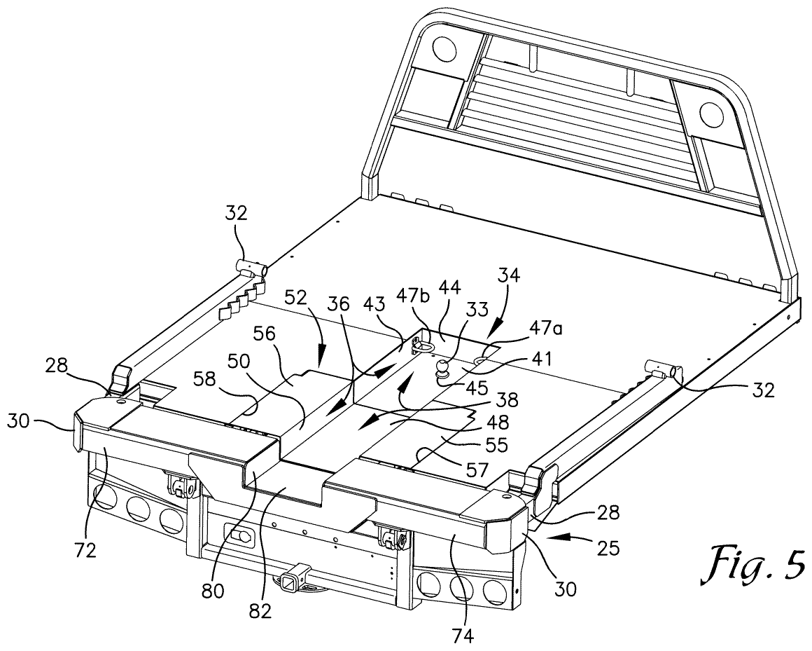

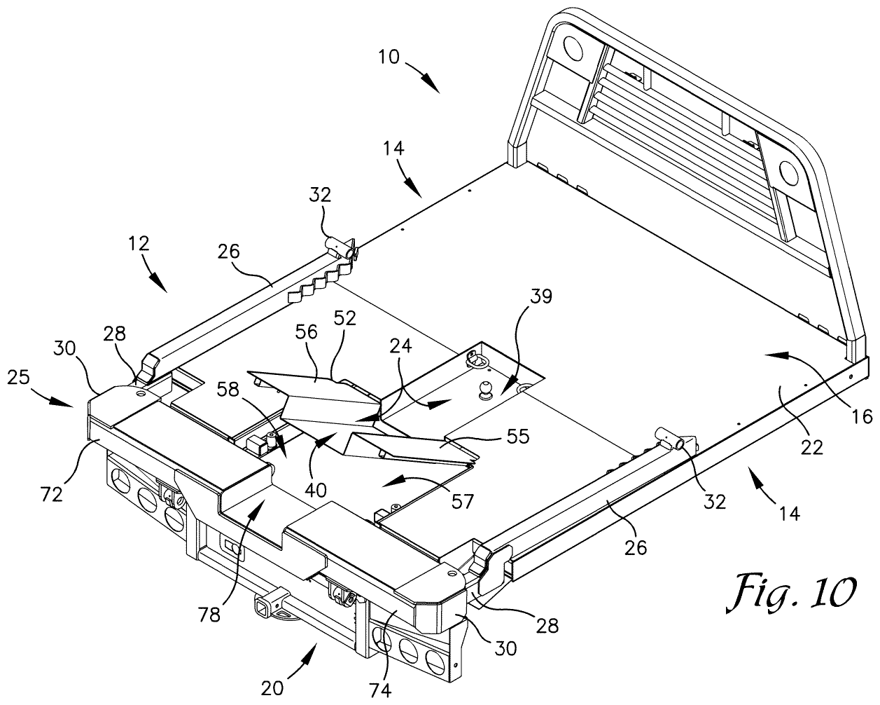

In the embodiment shown, the inlet section 40 of trough 24 is formed in an access door or access hatch 52. Access hatch 52 is pivotably attached to chassis 18 proximate the trailing edge of the hitching section 39 of the trough 24 and includes a recessed portion which defines the inlet section 40 of the trough 24. Access hatch 52 is pivotable about an axis extending transverse to a longitudinal axis of the truck bed and between a closed position (see FIGS. 4 and 5) and an open position (see FIG. 10). In a preferred embodiment, access hatch 52 is pivotable approximately 60°. When access hatch 52 is in the closed position, the inlet section 40 of trough 24 extends in alignment with the hitching section 39 of trough 24 to define a cuboid space across which the trailer coupler may be advanced to position the coupler in alignment with the hitch ball 33 mounted in the hitching section 39 of the trough 24.

When access hatch 52 is in the closed position, inlet section floor 48 is generally flush with trough floor 38, such that inlet section floor 48 and trough floor 38 extend in an approximately common plane. In some embodiments, the first and second inlet section side walls 49 and 50 may also be flush with the first and second mounting section side walls 42 and 43, respectively, when access hatch 52 is in the closed position. However, without departing from the scope of embodiments of the invention described herein, the first and second inlet section side walls 49 and 50 may deviate from flush relative to the first and second mounting section side walls 42 and 43, respectively, when access hatch 52 is in the closed position.

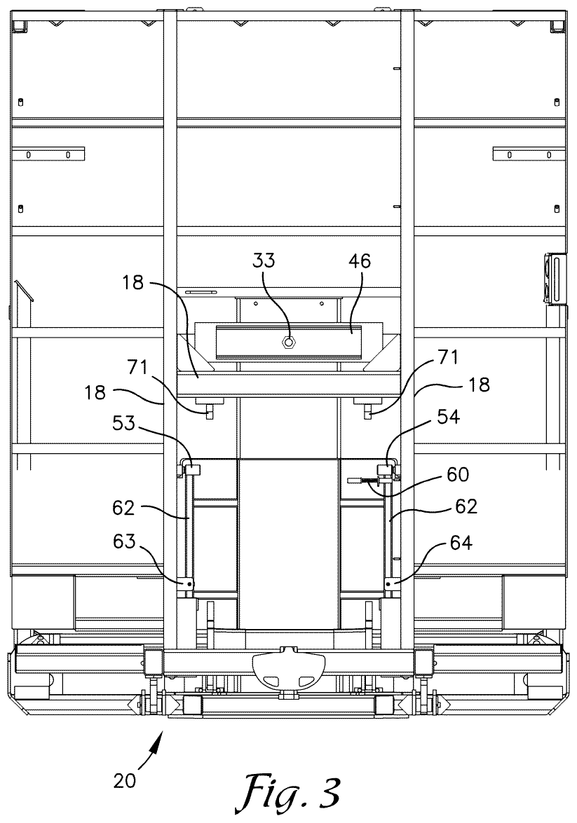

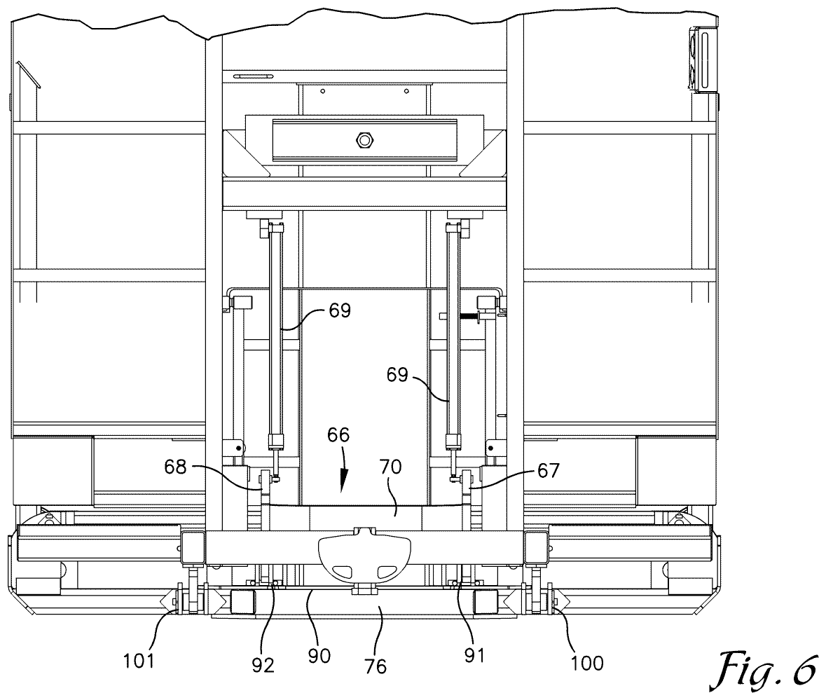

With reference to FIG. 3, access door 52 pivots about an axis transverse to the length of the truck bed 10 and defined by rotating couplers 53 and 54. Rotating couplers 53 and 54 are connected between the chassis 18 and the underside of access door 52 on opposite sides of the trough 24. A user or technician may pivot access door 52 open to obtain entry to the area beneath the truck bed panel 16 for maintenance or other purposes. Such access may be necessary to, for example, maintain or adjust one or more hydraulic actuators 69 that are mounted to the chassis 18 in some embodiments (see FIG. 6).

Access door 52 includes shoulder plates 55 and 56 which extend horizontally in diametrically opposite directions from the upper edges of the first and second inlet section side walls 49 and 50, respectively. Typically, shoulder plates 55 and 56 are integrally formed with the first and second inlet section side walls 49 and 50. Cut-outs or recessed openings 57 and 58 are formed in the truck bed panel 16 and mirror the dimensions of shoulder plates 55 and 56. When access door 52 is in the closed position, shoulder plates 55 and 56 nest within the recessed openings 57 and 58, respectively, rendering the upper surfaces of shoulder plates 55 and 56 flush with truck bed floor 16.

At least one spring or other biasing means 60 is connected to the access door 52 and engageable to normally bias the access door 52 to the closed position. In the embodiment shown, spring 60 is disposed adjacent at least one of the rotating couplers 53 and 54. Spring 60 is attached to a hatch frame 62 generally comprising interconnected support members disposed across lower surfaces of shoulder plates 55 and 56. The hatch frame 62 prevents and controls torquing and/or twisting of shoulder plates 55 and 56, thereby structurally supporting access door 52.

Dampeners 63 and 64 are attached to horizontally opposite beams of the chassis 18. Typically, dampeners 63 and 64 are disposed between rotating couplers 53 and 54, respectively, and the rear end of base unit 14. When access door 52 is advanced to the closed position, members of the hatch frame 62 contact dampeners 63 and 64. When a user or technician pivots access door 52 from the open position to the closed position, dampeners 63 and 64 contact members of the hatch frame 62, thereby absorbing the momentum of the access hatch 52.

With reference to FIG. 6, the lift arm assembly 12, and typically the crossmember 25 thereof, is connected to the base unit 14 by a lift arm linkage 66. Lift arm linkage 66 is disposed beneath the rear end of base unit 14. Lift arm linkage 66 includes drive linkages 67 and 68, which are disposed on laterally opposite sides of the centerline of the inlet section 40 of trough 24. Drive linkages 67 and 68 are anchored to one another by a cross-bar or laterally extending linkage 70 extending therebetween. At their respective forward ends, holes are formed in the drive linkages 67 and 68 which are alignable with clevises 91 and 92 projecting from crossmember 25 to permit connection of the lift arm linkage 66 to crossmember 25.

When lift arm assembly 12 is in the retracted position, crossmember 25 is disposed across the rear end of base unit 14 above the bumper structure 20. Actuation of lift arm linkage 66 pivots crossmember 25 about an axis transverse to the longitudinal axis of the truck bed 10, thereby pivoting the lift arm assembly 12 between the extended and retracted positions. In a preferred embodiment, crossmember 25 is pivotable through a range of motion of approximately 210°. In some embodiments, actuation of lift arm linkage 66 may also allow for vertical displacement of crossmember 25. Actuation of lift arm linkage 66 is preferably provided by one or more hydraulic actuators 69, but pneumatic, mechanical, electrical, or other apparatus can be used. At their respective rear ends, drive linkages 67 and 68 have holes formed therein to which one end of each actuator 69 may be connected, with an opposite end of each actuator 69 connected to actuator mounts 71 connected to the chassis 18 under the mounting section 39 of trough 24 forward of the lift arm linkage 66 with the actuators 69 extending under the access hatch 52. Controls for operation of the actuators 69 may be provided inside the cab of the vehicle and/or located on, for example, the base unit 14. Remote control systems might also be employed.

The inner end 28 of each lift arm 26 is pivotably attached to a respective opposite end 30 of the crossmember 25. When lift arm assembly 12 is in the retracted position, each lift arm 26 assumes a stowed position atop the loading surface 22 wherein each lift arm 26 is adjacent to substantially opposite side edges of truck bed floor 16. In the stowed position, each lift arm 26 extends from the rear end of base unit 14 toward the forward end of base unit 14. As lift arm assembly 12 moves from the retracted position to the extended position, each lift arm 26 moves concomitantly through an arc over the rear edge of base unit 14 to an extended position such that when the lift arm assembly 12 is in the extended position, the lift arms 26 extend rearwardly and away from the rear end of base unit 14, where they may engage a bale or reel or other object (not shown). Moving lift arm assembly 12 from the extended position to the retracted position reverses the concomitant arc movement of lift arms 26 and may lift the engaged bale, reel, or other object onto loading surface 22.

In some embodiments, actuators or other pivoting means disposed in crossmember or strut 25 couple to lift arms 26 and are configured to pivot distal ends 32 of lift arms 26 toward and away from one another for engaging and disengaging a bale, reel, or other object (not shown) therebetween. U.S. Pat. No. 10,212,887 to Ramer et al. describes an exemplary configuration of lift arms 26 pivotably movable to engage and disengage a bale, reel, or other object. The disclosure provided by the '887 patent with respect to such an exemplary pivotably movable configuration is incorporated herein by reference.

In other embodiments, actuators or other means disposed in crossmember or strut 25 may translationally or slidably move lift arms 26 toward/away from one another to engage and disengage a bale, reel, or other object. U.S. Pat. No. 4,594,041 to Hostetler describes an exemplary configuration useable to translationally move the lift arms 26 toward/away from one another. The disclosure provided by the '041 patent with respect to such an exemplary translationally moveable configuration is incorporated herein by reference.

Crossmember 25 is formed from outer tube sections 72 and 74 connected together in spaced relation by an offset connecting beam 76 which extends generally under the outer tube sections 72 and 74. Opposite ends of the offset connecting beam 76 may be welded to the underside of inner ends of the outer tube sections 72 and 74, with an offset or recess 78 formed between the outer tube sections 72 and 74. The recess 78 is centrally oriented between opposite ends 30 of the crossmember 25 with the inner ends of the outer tube sections 72 and 74 forming first and second offset side walls or first and second recess side walls 79 and 80 which define the offset or recess 78. A cross-section of the recess 78 is sized similar to a cross-section of the trough across the mounting section 39 and the inlet section 40. In an embodiment, the first and second recess side walls 79 and 80 are generally flush with the first and second trough side walls 36 and 37 such that the first recess side wall 79 and the first trough side wall 36 extend in an approximately common plane and the second recess side wall 80 and the second trough side wall 37 extend in an approximately common plane, such that the trough 24 and the recess 78 may be said to be “alignable” with each other.

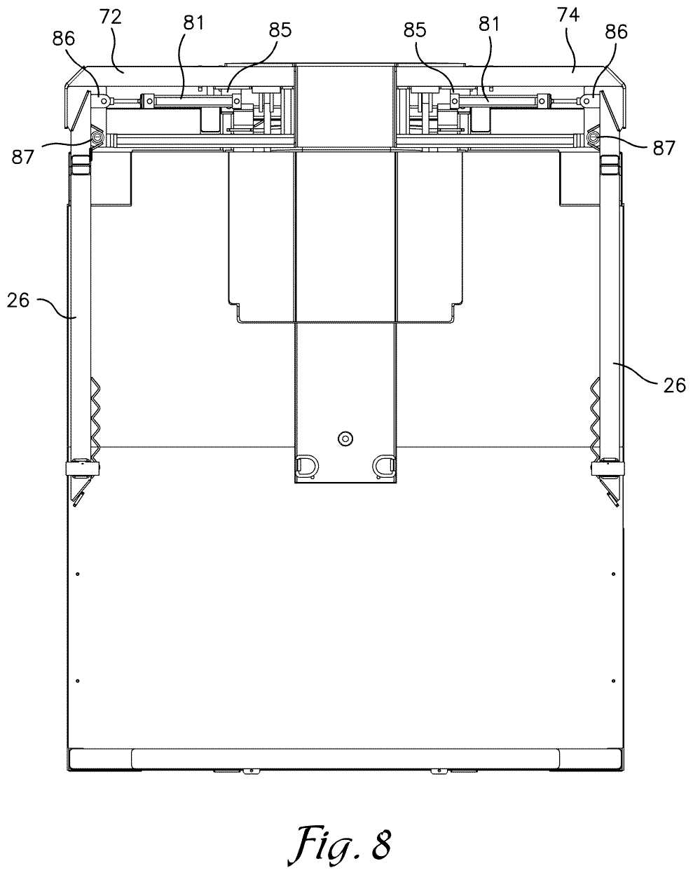

A cover plate 82 may be welded over the offset connecting beam 76 between the inner ends of the outer tube sections 72 and 74, and cover panels 83 and 84 may be welded on top of the outer tube sections 72 and 74 to cover the outer tube sections 72 and 74. Referring to FIG. 8, with the cover panels 83 and 84 removed, lift arm actuators 81 are preferably connected between a first actuator mount 85 on a front-facing surface of each outer tube section 72 and 74 and a second actuator mount 86 on an inner surface of the inner end 28 of each lift arm 26. In the embodiment shown, each lift arm 26 is pivotally connected to a respective outer tube section 72 or 74 by a pivot assembly or hub 87 connected between an inner surface of the respective outer tube section 72 or 74 and an inner surface of the respective lift arm 26 forward of the second actuator mount 86. In some embodiments, the first and second recess side walls 79 and 80 may be integrally formed with cover plate 82. Typically, the first and second recess side walls 79 and 80 extend approximately orthogonally from cover plate 82, but the first and second recess side walls 79 and 80 may also extend acutely or obtusely from cover plate 82.

When lift arm assembly 12 is in the retracted position, cover plate 82 preferably extends flush with or approximately flush with inlet section floor 48, such that cover plate 82 and inlet section floor 48 are approximately coplanar. In some embodiments, the first and second recess side walls 79 and 80 which define the recess 78 may also be flush with the first and second trough side walls 36 and 37 (and, in some embodiments, flush with the first and second inlet side walls 49 and 50) which define trough 24. However, without departing from the scope of embodiments of the invention described herein, the first and second recess side walls 79 and 80 may deviate from flush relative to the first and second trough side walls 36 and 37 and/or the first and second inlet side walls 49 and 50.

Offset 78 is sized sufficient to accommodate traversal thereacross of a trailer coupler when a trailer is coupled to or decoupled from the hitch ball 33 that is attached to the truck bed 10 and when the lifting assembly 12 is in the retracted position. The offset 78 is typically a substantially rectangular prism, and it is understood that without departing from the scope of embodiments of the invention described herein the offset 78 may be substantially trapezoidal or may comprise some other geometry.

When lifting assembly 12 is in the retracted position, a trailer coupler can thus traverse through or just above the offset 78 and the trough 24, reducing the height a user has to jack up the front of the trailer and enabling a user to more efficiently couple and decouple a trailer to the truck bed 10. As indicated previously, the trough 24 may serve as a guide to allow a truck driver to more efficiently advance the trailer coupler toward the hitch ball 33 as a truck approaches a trailer during the coupling process. The offset 78 may also function as a guide for the driver to guide the trailer coupler through or just above the offset 78, further minimizing the amount of horizontal manipulation of a truck and/or trailer needed for coupling. A user can thereby couple a trailer to a truck without extensively raising and/or lowering the trailer.

Crossmember 25 may torque and/or twist when lift arms 26 engage a bale or reel and as the lift arm assembly 12 moves between the extended and retracted positions. Such torquing may be reduced or mitigated by structural reinforcement means, including the cover plate 82. Cover plate 82 complements the shape of the offset 78 and may be secured to the first and second recess side walls 79 and 80. Offset connecting beam 76 extends beneath recess 78 to connect the inner ends of outer tube sections 72 and 74. In the embodiment shown, crossmember 25 is additionally reinforced by a rear gusset plate 88 connecting the rearward faces of outer tube sections 72 and 74 and an internal gusset plate 90 connecting the forward faces of outer tube sections 72 and 74. Referring to FIG. 6, clevises 91 and 92, which mate with the holes in drive linkages 67 and 68 to connect lift arm linkage 66 to crossmember 25, are shown mounted to internal gusset plate 90.

When lift arm assembly 12 is in the retracted position, an upper member 94 of bumper structure 20 is disposed beneath cover plate 82 and proximate the rear end of base unit 14. Bumper structure 20 extends downwardly from upper member 94 in a direction substantially perpendicular to loading surface 22. A lower member 96 of bumper structure 20 is disposed beneath upper member 94. Side members 97 and 98 connect upper member 94 to lower member 96. In some embodiments, lower member 96 may contain an auxiliary hitch receiver 99 for installing a hitch ball or other means to connect the truck bed 10 to a trailer that is not equipped with a gooseneck coupler.

The crossmember 25 is pivotably connected to the bumper structure 20 by hinges or rotating joints 100 and 101, which define the axis transverse to the truck about which lift arm assembly 12 pivots when lift arm linkage 66 is actuated. Knuckles 102 of hinges 100 and 101 are anchored to side members 97 and 98 of the bumper structure 20. Hinge leaves or clevises 104 of rotating joints 100 and 101 are anchored to the lower faces of the outer tube sections 72 and 74. When lift arm assembly 12 is in the extended position, the offset 78 of the crossmember 25 is out of alignment with trough 24. As the lift arm linkage 66 is actuated and lift arm assembly 12 pivots to the retracted position, offset 78 of crossmember 25 comes into alignment with trough 24.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure is intended to demarcate those structures as including a plurality of possible arrangements or designs within the scope of this disclosure and readily identifiable by one of skill in the art to perform the particular function in a similar way without specifically listing all such arrangements or designs. Certain features and sub-combinations are of utility and may be employed without reference to other features and sub-combinations and are contemplated within the scope of the claims.

What is claimed is:

1. A truck bed comprising:
a base unit having a truck bed floor with a loading surface;
a crossmember pivotably mounted along a rear end of the base unit, the crossmember pivotable between a retracted position and an extended position about an axis extending transverse to a longitudinal axis of the truck bed;
a pair of lift arms connected to opposite ends of the crossmember;
a trough formed in the truck bed floor centrally between opposite sides of the truck bed floor, the trough extending downwardly from the truck bed floor and extending rearwardly through a rear end of the base unit; and
a recess centrally oriented between opposite ends of the crossmember, the recess alignable with the trough.

2. The truck bed as in claim 1, wherein a linkage mounts the crossmember to the rear end of the base unit and the linkage is actuatable to pivot the crossmember between the retracted position and the extended position.

3. The truck bed as in claim 1, wherein the trough is sized sufficiently wide to accommodate traversal of a trailer coupler thereacross.

4. The truck bed as in claim 3, wherein the trough is an approximately rectangular prism.

5. The truck bed as in claim 3, wherein a trough floor extends below the loading surface of the truck bed floor a distance less than the height of a hitch ball secured within the trough.

6. The truck bed as in claim 3, wherein a cross-section of the recess is sized similar to a cross-section of the trough.

7. The truck bed as in claim 6, wherein a first recess side wall is flush with a first trough side wall and a second recess side wall is flush with a second trough side wall when the crossmember is pivoted to the retracted position.

8. The truck bed as in claim 1, wherein a hole is formed in a trough floor extending below the loading surface of the truck bed floor, the hole providing access to a hitch ball mount secured to the base unit below the truck bed floor.

9. A truck bed comprising:
a base unit securable to a truck frame, the base unit having a chassis with a truck bed floor mounted thereto, the truck bed floor having a loading surface;
a trough extending downward from the loading surface, the trough having a mounting section and an inlet section, the mounting section disposed between the inlet section and a forward end of the trough, and the inlet section extending rearwardly through a rear end of the truck bed floor;
a crossmember pivotably mounted along a rear end of the base unit and pivotable about an axis extending transverse to a longitudinal axis of the truck bed and between a retracted position and an extended position, the crossmember having a pair of outer tube sections with an offset centrally disposed therebetween, the offset alignable with the trough; and
a linkage mounting the crossmember to the base unit, the linkage actuatable to pivot the crossmember between the retracted position and the extended position.

10. The truck bed as in claim 9, further comprising:
a pair of lift arms pivotably connected to opposite ends of the crossmember, each of the pair of lift arms being pivotable between a stowed position and an extended position.

11. The truck bed as in claim 9, further comprising:
an access hatch having a recessed portion, the access hatch pivotably attached to the chassis proximate a trailing edge of the mounting section, the access hatch pivotable about an axis extending transverse to a longitudinal axis of the truck bed, whereby the recessed portion of the access hatch defines the inlet section of the trough.

12. The truck bed as in claim 11, wherein the access hatch has a pair of shoulder plates extending horizontally in diametrically opposite directions, each one of the pair of shoulder plates structurally supported by a hatch frame disposed across a lower surface thereof.

13. The truck bed as in claim 12, further comprising:
at least one spring attached to the hatch frame, the at least one spring engageable to bias the access hatch to a closed position; and
at least one dampener attached to the chassis, the at least one dampener contactable with the hatch frame.

14. The truck bed as in claim 9, wherein a cross-section of the offset is sized similar to a cross-section of the mounting section, and the cross-section of the offset is sized similar to a cross-section of the inlet section.

15. The truck bed as in claim 14, wherein, when the crossmember is pivoted to the retracted position, a first offset side wall and a first mounting section side wall and a first inlet section side wall extend in an approximately common plane, and a second offset side wall and a second mounting section side wall and a second inlet section side wall extend in an approximately common plane.

16. The truck bed as in claim 9, wherein a hole is formed in a mounting section floor, the hole providing access to a hitch ball mount secured to the chassis below the mounting section floor.

17. A truck bed comprising:
a base unit secured to a truck frame, the base unit having a truck bed floor with a loading surface;
a pair of lift arms disposed proximate opposite sides of the base unit;
a trough centrally oriented between opposite sides of the base unit and extending downwardly from the loading surface, the trough having a hitching section;
an access door having a recessed portion, the access door pivotably attached to the base unit proximate a trailing edge of the hitching section, the recessed portion alignable with the hitching section;
a crossmember pivotably mounted along a rear end of the base unit, the crossmember pivotable about an axis extending transverse to a longitudinal axis of the truck bed between a retracted position and an extended position; and
an offset centrally oriented between opposite sides of the crossmember, the offset alignable with the recessed portion.

18. The truck bed as in claim 17, wherein the rear end of the base unit comprises a bumper structure disposed beneath the truck bed floor, the bumper structure including a pair of hinges defining the axis about which the crossmember is pivotable.

19. The truck bed as in claim 17, further comprising:
at least one linkage mounting the crossmember to the base unit, the at least one linkage actuatable to pivot the crossmember between the retracted position and the extended position.

20. The truck bed as in claim 17, wherein a cross-section of the mounting section is sized similar to a cross-section of the offset, and the cross-section of the mounting section is sized similar to a cross-section of the recessed portion.
